(19) United States
(12) Patent Application Publication
(10) Pub. No.: US 2017/0141611 A1
(43) Pub. Date: May 18, 2017

(54) FURNITURE WITH EMBEDDED ELECTRICAL POWER SOURCES WITH ELECTRICITY SUPPLIED BY NON-CONTIGUOUS POWER SUPPLIES WITHOUT A CORD OR TETHER

(71) Applicant: Willard C. Somers, Rumson, NJ (US)

(72) Inventor: Willard C. Somers, Rumson, NJ (US)

(21) Appl. No.: 14/941,820

(22) Filed: Nov. 16, 2015

(51) Int. Cl. H02J 50/00; H02J 7/02

(52) U.S. Cl. CPC H02J 50/00; H02J 7/025

(57) ABSTRACT

A furniture product encompassing a method and system for facilitating charging of devices directly from a piece of furniture without “wall attached” tether or cord. The system performs the function of providing power to household electronic devices such as, but not limited to, mobile telephones, tablets and portable computers. While the method of charging the device is flexible to accommodate various charging schemas, no cord or tether from the piece of furniture to a wall plug is required.

### BACKGROUND OF THE INVENTION

1. Technical Field

The present invention relates in general to the field of FURNITURE and HOME FURNISHINGS, and in particular to function provided by such articles. Still more particularly, the present invention relates to the function of providing power to household electronic devices such as, but not limited to, mobile telephones, tablets and portable computers.

2. Description of the Related Art

As technology has moved rapidly in the features, numbers and use of electronic devices and the lowering of their power requirements, an approach has become possible to recharging such devices. In this case, power sources can transmit power over one of several mediums “over the air,” without a wired connection.

### SUMMARY OF THE INVENTION

Recognizing the problems with wires in home settings (danger of tripping and falling, etc.), a solution is needed to allow connection of electronic devices to electrical power sources in or on a piece of furniture with electricity supplied by non-contiguous power supplies without a cord or tether of any kind. This invention connects a power “strip” or “pad” to the non-contiguous power supply.

In one embodiment of the invention, the electricity is “beamed” by one of several methods, cited or uncited, to a receptacle embedded in the piece of furniture. In turn the receiver is connected to a “power strip” or “pad” to enable the functioning and recharging of an electronic device with no wiring running across the floor.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a flow of electricity 101 from a wall outlet 102 to an embedded receiver 103 in the furniture piece 104;

FIG. 2 illustrates a routing flow of electricity 109 from the embedded receiver 103 to the “power strip,” “pad” 106 or other similar device;

FIG. 3 depicts the flow of powering and recharging electricity 110 from the “power strip” or “pad” 106 to the device 107;

FIG. 4 depicts an exemplary furniture item 104 in which the present invention may be implemented;

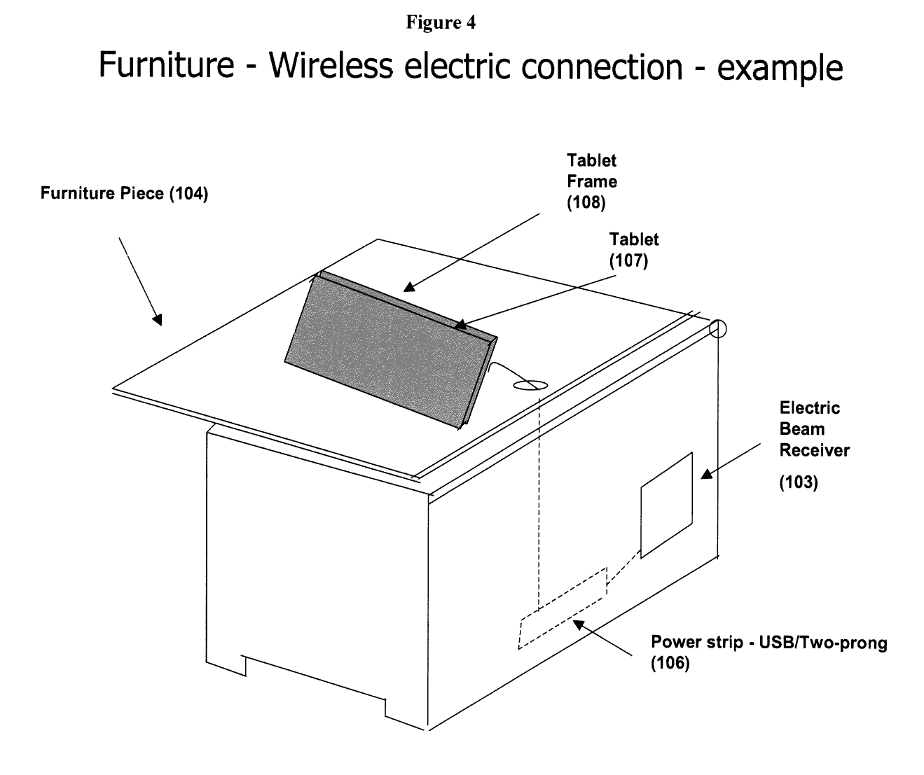

FIG. 5 illustrates an exemplary wall plug server 105 from which electricity for executing the present invention may be procured;

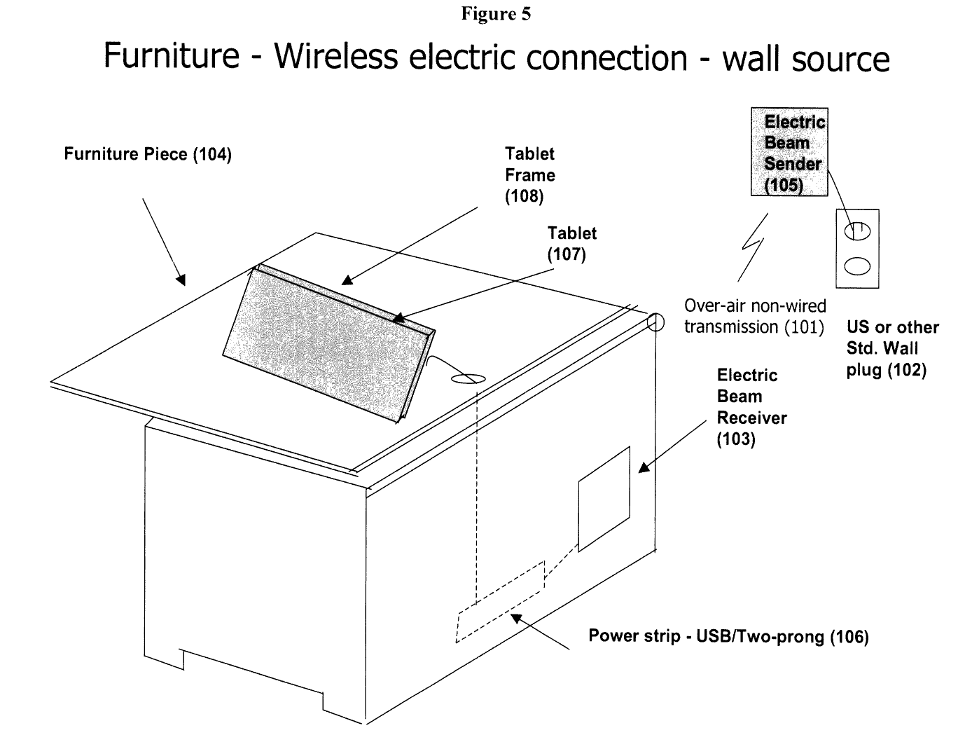

FIGS. 6 show a flowchart showing the progress of electrical current in the steps 111-115 which transpire to execute the steps shown and described in FIGS. 1-3;

### DETAILED DESCRIPTION OF THE PREFERRED EMBODIMENT

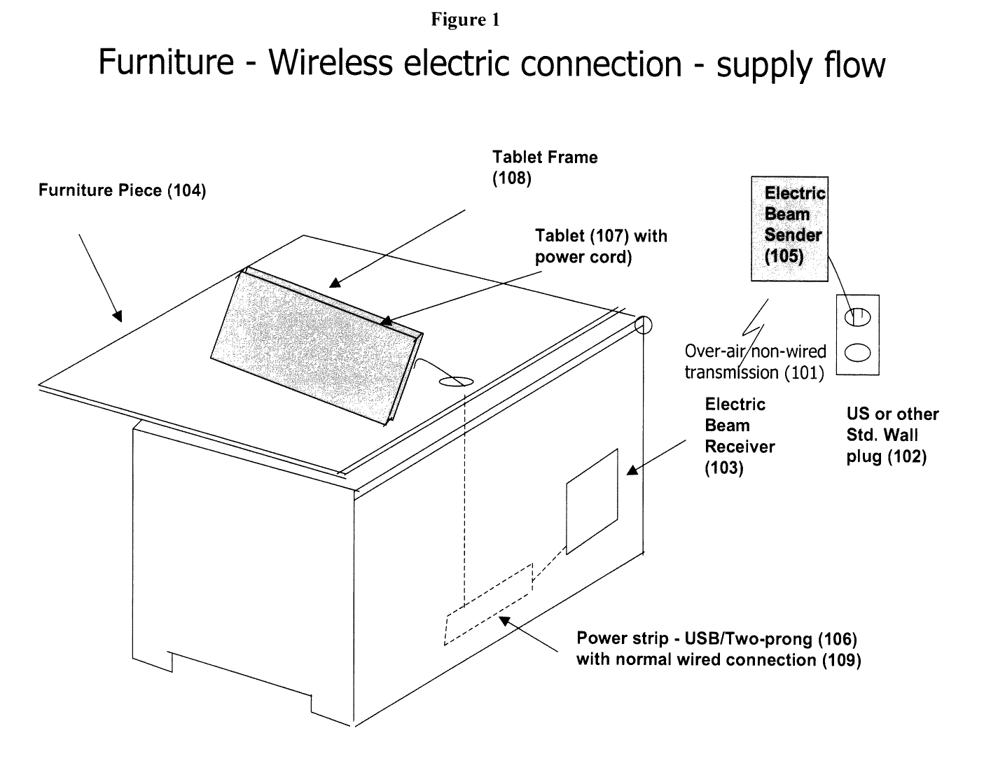

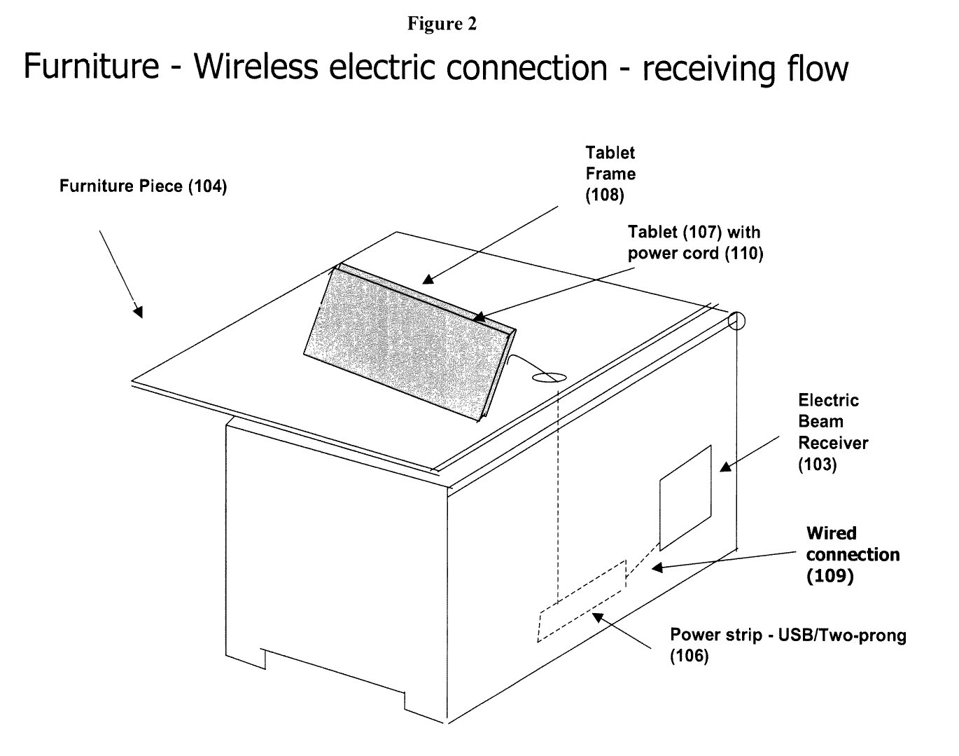

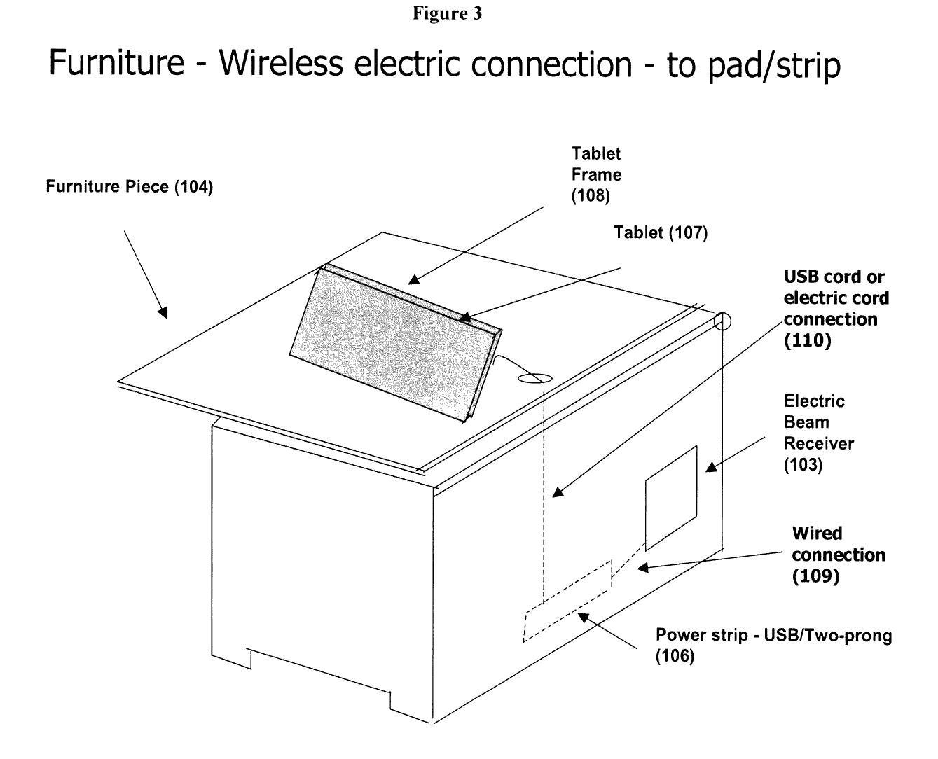

With reference now to the figures, and in particular to FIGS. 1, 2 and 3, a routing flow of outgoing electricity in accordance with the method and system described therein is depicted. A device 107 (e.g., mobile telephone, “smartphone'” laptop computer, tablet computer, PDA, notebook computer, etc.) (via its power and charging cord, or other pathway 109) is attached to, or in the case of a “pad,” laid on, the power and/or charging surface 106 embedded in the furniture item 104.

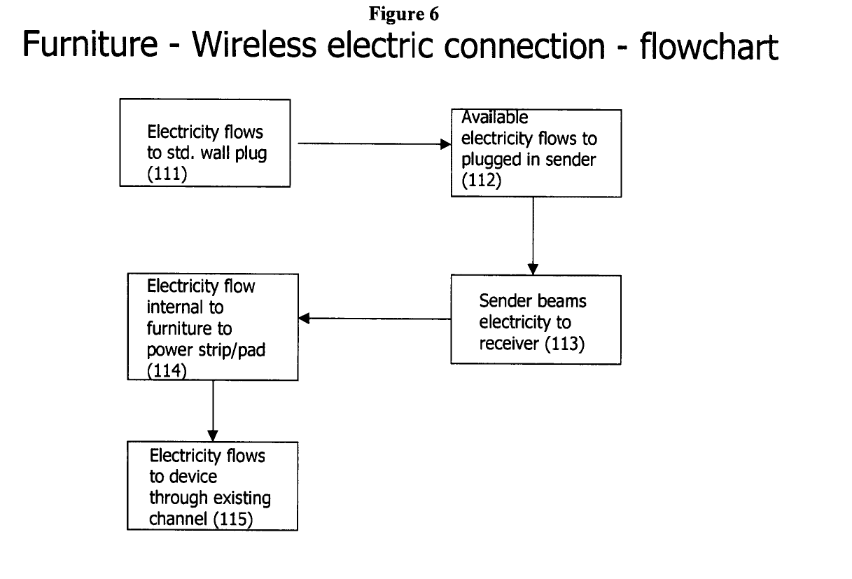

Referring now to FIG. 6, a flowchart of the steps 111-115 described in FIGS. 1-3 is presented.

Normal household wiring presents a flow of electricity at a wall outlet 102.

A “server” 105 plugged into the a wall outlet 102 “beams” electricity 101 to an embedded receiver 103 in the furniture piece 104;

Wiring 109 internal to the furniture piece 104 provides a routed flow of electricity from the embedded receiver to the “power strip,” “pad” 106 or other similar device;

Electricity flows from the “power strip” or “pad” 106 to the device 107 through methods outside of this invention, providing power or recharging to the device.

It should be understood that at least some aspects of the present invention may alternatively be implemented in a “software-driven” medium that contains a program product for the “smartphone,” tablet or computer 107. Such a program product may be delivered by means such as computer and telephone networks including Ethernet, the Internet, wireless networks, and similar network systems. It should be understood, therefore, that software media implementing functions of the present invention, represent alternative embodiments of the present invention. Further, it is understood that the present invention may be implemented by a system having means in the form of hardware (as described herein), software, or a combination of software and hardware or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” includes any microprocessor based system including, but not limited to, personal computers, network computers, routers, switches, “smartphones,” telephones, and any other system capable of processing, transmitting, receiving, capturing and/or storing data.

What is claimed is:

1. A method of routing electrical energy to and from a piece of furniture, the method comprising: receiving electricity over a wireless connection and rendering it via a series of connections to a device for purposes of recharging or operation.

2. The method of claim 1, wherein the device is connected to a plug or receptacle exposed or internal to the piece of furniture,

3. The method of claim 2, wherein the device is placed adjacent to or in proximity to a charging surface or “pad” on the piece of furniture.
